(19) United States
(12) Patent Application Publication
(10) Pub. No.: US 2026/0014537 A1
(43) Pub. Date: Jan. 15, 2026

(54) LITHIUM SULFIDE PRODUCTION APPARATUS

(71) Applicant: LAKE TECHNOLOGY., LTD, Sejong-si (KR)

(72) Inventors: Seong Hoon JEONG, Cheonan-si Chungcheongnam-do (KR); Sang Yun LEE, Sejong-si (KR); Sung Yoon BAEK, Sejong-si (KR); Teak Seung YANG, Icheon-si Gyeonggi-do (KR); Chang Ho SONG, Cheongju-si Chungcheongbuk-do (KR); Jin dong KIM, Sejong-si (KR)

(73) Assignee: LAKE TECHNOLOGY., LTD, Sejong-si (KR)

(21) Appl. No.: 19/335,187

(22) Filed: Sep. 22, 2025

Related U.S. Application Data
(63) Continuation of application No. PCT/KR2024/095546, filed on Mar. 14, 2024.

(30) Foreign Application Priority Data
Mar. 22, 2023 (KR) 10-2023-0037273

(51) Int. Cl. B01J 8/12; B01D 53/26; B01J 8/00; B01J 8/08; B01J 8/10; C01B 17/22

(52) U.S. Cl. CPC B01J 8/12; B01D 53/265; B01J 8/0015; B01J 8/085; B01J 8/087; B01J 8/10; C01B 17/22; B01D 2257/80; B01J 2208/00176; B01J 2208/00752; B01J 2208/00805; B01J 2208/00867

(57) ABSTRACT

Provided is an apparatus for manufacturing lithium sulfide, including a plurality of reaction chambers having a reaction space for producing lithium sulfide by a reaction between a lithium raw material and hydrogen sulfide and provided to move the supplied lithium raw material along one direction, and the lithium raw material is sequentially supplied to the plurality of reaction chambers along the one direction, and the hydrogen sulfide is sequentially supplied to the plurality of reaction chambers along a direction opposite to the one direction from any one of the plurality of reaction chambers other than the reaction chamber into which the lithium raw material is supplied.

### CROSS-REFERENCE TO RELATED APPLICATIONS

This application is a continuation of International Application No. PCT/KR2024/095546 filed on Mar. 14, 2024, which claims priority to Korean Patent Application No. 10-2023-0037273 filed on Mar. 22, 2023, the entire contents of which are herein incorporated by reference.

### TECHNICAL FIELD

The present invention relates to an apparatus for manufacturing lithium sulfide.

### BACKGROUND ART

Lithium secondary batteries have high energy density and long lifetimes, and thus they are widely used in electronic devices such as home appliances, laptop computers, and smartphones. Recently, their utilization has been greatly increasing, as they are also mounted on electric vehicles (EVs) and hybrid electric vehicles (HEVs).

Lithium-ion secondary batteries that are mainly used today have been widely used as the main power source for mobile phones, laptop computers, and PCs since mass production began in 1991, thanks to their high energy density and output voltage. However, an organic electrolyte that is included to facilitate the migration of lithium ions includes a risk of explosion under overheating and overcharging conditions. Furthermore, it may easily ignite in the presence of an ignition source, and side reactions within the battery may cause gas generation, deteriorating battery performance and stability.

To overcome these shortcomings of lithium-ion secondary batteries, active research and development is underway on all-solid-state lithium secondary batteries. All-solid-state lithium secondary batteries not only reduce the risk of explosion by employing a solid electrolyte instead of a volatile electrolyte, but also offer the advantage of dramatically improving battery energy density by allowing the use of lithium metal or a lithium alloy as a negative electrode material.

Today, among the solid electrolyte candidates that may be included in all-solid-state batteries, sulfide-based solid electrolytes, known for their high ductility and ionic conductivity, are evaluated as suitable for manufacturing high-capacity, large-scale secondary batteries, and lithium sulfide (Li₂S) is evaluated as a key material in the manufacturing process of such sulfide-based solid electrolytes. Various methods of synthesizing lithium sulfide are known, but the most common method is known to be allowing lithium metal, such as lithium hydroxide (LiOH) or lithium carbonate (Li₂CO₃), to react with hydrogen sulfide (H₂S).

Meanwhile, conventional technologies have problems in that when lithium metal, such as lithium hydroxide, is allowed to react with hydrogen sulfide, the supplied hydrogen sulfide may be discharged without fully reacting, or the reaction rate of hydrogen sulfide may be low, hindering the economic feasibility of lithium sulfide mass production.

In addition, reacting lithium metal, such as lithium hydroxide, with hydrogen sulfide inevitably generates water vapor, which not only interferes with the contact between lithium metal and hydrogen sulfide, reducing the yield of lithium sulfide, but also reacts with lithium sulfide to accelerate a reverse reaction of lithium sulfide into lithium hydroxide, thereby reducing the purity of the resulting lithium sulfide. Furthermore, moisture may cause agglomeration between the produced lithium sulfide particles, deteriorating product quality.

Accordingly, the present inventors have studied a method for producing lithium sulfide with high purity and high yield by utilizing a reaction of lithium metal and hydrogen sulfide to produce lithium sulfide, while consuming all of the hydrogen sulfide to improve the reaction rate of hydrogen sulfide and effectively removing water vapor generated as a reaction product, and as a result, have completed the present invention.

### SUMMARY

### Technical Problem

The present invention has been proposed to solve the above-described problems and aims to provide an apparatus for manufacturing lithium sulfide, which is suitable for mass production of lithium sulfide with high purity and high yield by improving the reaction rate of hydrogen sulfide when producing lithium sulfide through a reaction between lithium metal and hydrogen sulfide.

### Technical Solution

In one example, an apparatus for manufacturing lithium sulfide includes a plurality of reaction chambers having a reaction space for producing lithium sulfide by a reaction between a lithium raw material and hydrogen sulfide and provided to move the supplied lithium raw material along one direction, the lithium raw material is sequentially supplied to the plurality of reaction chambers along the one direction, and the hydrogen sulfide is sequentially supplied to the plurality of reaction chambers along a direction opposite to the one direction from any one of the plurality of reaction chambers other than the reaction chamber into which the lithium raw material is supplied.

In another example, in a reaction chamber into which the lithium raw material is initially supplied, a large amount of lithium raw material may be present compared to the amount of lithium sulfide produced, and in a reaction chamber into which the hydrogen sulfide is initially supplied, a large amount of hydrogen sulfide may be present compared to the amount of lithium sulfide produced.

In still another example, in the plurality of reaction chambers, the hydrogen sulfide in the reaction chamber may have a reaction rate that increases toward an upstream side of the one direction.

In yet another example, the plurality of reaction chambers may include a first reaction chamber, a second reaction chamber, and a third reaction chamber connected in series, and the apparatus may further include: a lithium raw material supply portion provided to supply the lithium raw material to the first reaction chamber; and a hydrogen sulfide supply portion provided to supply the hydrogen sulfide to the third reaction chamber.

In yet another example, the apparatus may further include: a lithium raw material supply portion provided to supply the lithium raw material to the reaction chamber; a hydrogen sulfide supply portion provided to supply the hydrogen sulfide to the reaction chamber; a plurality of heating portions respectively provided in the plurality of reaction chambers to heat the reaction space; and a lithium sulfide recovery portion provided to recover lithium sulfide produced in the reaction chamber.

In yet another example, the apparatus may further include: an inert gas supply portion provided in the reaction chamber located most downstream along the one direction among the plurality of reaction chambers to supply an inert gas into the reaction chamber; and an inert gas discharge portion provided in the reaction chamber located most upstream along the one direction among the plurality of reaction chambers to discharge the inert gas in the reaction chamber.

In yet another example, the plurality of chambers may include an auxiliary chamber located downstream in the one direction relative to the chamber to which the hydrogen sulfide is supplied, and the apparatus may further include an inert gas supply portion supplying an inert gas to the auxiliary chamber.

In yet another example, the apparatus may further include: a transfer line provided between one of the reaction chambers located upstream in one direction and the other of the reaction chambers located downstream in one direction among a pair of adjacent reaction chambers, the transfer line providing a passage through which gas in the other of the reaction chambers flows into the one of the reaction chambers; and a moisture removal portion provided in the transfer line to remove water vapor in the gas flowing in the transfer line.

In yet another example, the reaction chamber may be made of Hastelloy X or stainless steel 310 (SUS 310).

In yet another example, the heating portion may be mounted on an outer surface of the reaction chamber and heat the reaction space to a temperature to 160° C. or more and less than 300° C.

In yet another example, the lithium raw material supplied from the lithium raw material supply portion to the reaction chamber has a particle size of 1 mm or less.

### Advantageous Effects

According to the present invention, when producing lithium sulfide through a reaction between lithium metal and hydrogen sulfide, the reaction rate of hydrogen sulfide can be improved by completely consuming the supplied hydrogen sulfide, thereby enabling mass production of high-quality lithium sulfide with high purity and high yield.

### DESCRIPTION OF DRAWINGS

FIG. 1 is a schematic diagram illustrating an apparatus for manufacturing lithium sulfide according to one embodiment of the present invention.

FIG. 2 is an exemplary diagram illustrating a lithium sulfide manufacturing process according to one embodiment of the present invention.

FIG. 3 is a schematic diagram illustrating an apparatus for manufacturing lithium sulfide according to another embodiment of the present invention.

FIG. 4 is a schematic diagram illustrating a moisture removal portion according to one embodiment of the present invention.

FIG. 5 is a schematic diagram illustrating a sublimation cooling portion according to one embodiment of the present invention.

FIG. 6 is a schematic diagram illustrating a sublimation cooling portion according to one embodiment of the present invention.

FIG. 7 is a schematic diagram illustrating a sublimation cooling portion according to one embodiment of the present invention.

### DETAILED DESCRIPTION

Hereinafter, embodiments of the present invention will be described in detail with reference to the accompanying drawings. When designating components in each drawing, it should be noted that, where possible, identical components are given the same reference numerals, even when they appear in different drawings.

Furthermore, when describing embodiments of the present invention, detailed descriptions of known components or functions will be omitted when they are deemed to hinder understanding of the embodiments of the present invention.

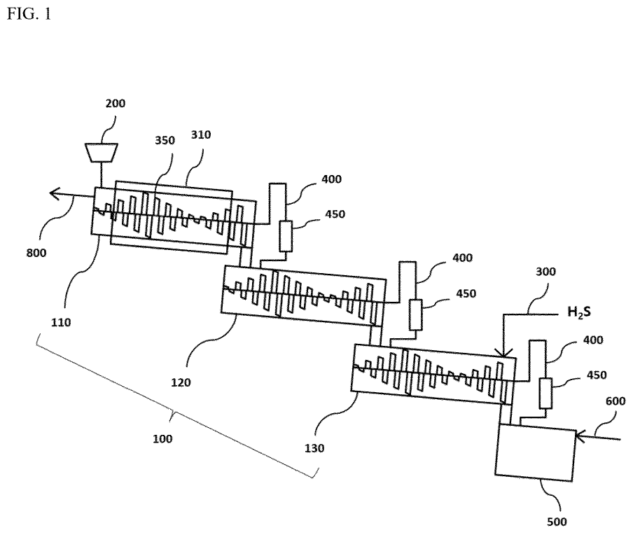

FIG. 1 is a schematic diagram illustrating an apparatus for manufacturing lithium sulfide according to one embodiment of the present invention. Hereinafter, an apparatus for manufacturing lithium sulfide according to one embodiment of the present invention will be described with reference to FIG. 1.

Referring to FIG. 1, an apparatus for manufacturing lithium sulfide according to one embodiment of the present invention may include a plurality of reaction chambers 100. In addition, the apparatus for manufacturing lithium sulfide according to the present invention may include a lithium raw material supply portion 200, a hydrogen sulfide supply portion 300, a moisture removal portion 450, a lithium sulfide recovery portion 500, an inert gas supply portion 600, and an inert gas discharge portion 800.

The plurality of reaction chambers 100 each have a reaction space for producing lithium sulfide through the reaction of a lithium raw material and hydrogen sulfide. For example, the plurality of reaction chambers 100 may include a first reaction chamber 110, a second reaction chamber 120, and a third reaction chamber 130 connected in series. The number of reaction chambers 100 is not particularly limited.

Each reaction chamber 100 is provided to move the supplied lithium raw material in one direction (e.g., from left to right in FIG. 1). The method and direction of moving the lithium raw material are not particularly limited. For example, as illustrated in FIG. 1, the bottom surface of the reaction chamber 100 may be formed to be inclined so that the lithium raw material may move by gravity. Alternatively, a conveyor belt (not shown) may be installed within the reaction chamber 100 to move the lithium raw material.

Meanwhile, a stirring member 350 may be further provided within the reaction chamber 100 to promote reaction and transfer. For example, a rotating disk, a rotary stirrer, a propeller, or the like may be employed as the stirring member 350, but is not particularly limited thereto.

In addition, a heating member 310 may be provided within the reaction chamber 100. The heating member 310 is provided to heat the reaction space and may be provided in each of the plurality of reaction chambers 100. The method by which the heating member 310 heats the reaction space is not particularly limited. For example, the heating member 310 may be a heater, an electric heating wire, or an infrared heater mounted on an outer surface of the reaction chamber 100.

In addition, the heating portion 310 may heat the reaction space to a temperature of 160° C. or more and less than 300° C. For the lithium raw material and hydrogen sulfide to react smoothly, the lithium raw material (lithium hydroxide) needs to be sufficiently heated. In addition, as described below, water (H₂O) is generated as a byproduct by the reaction between lithium hydroxide and hydrogen sulfide. When water is present in a liquid state, it may be introduced between lithium hydroxide particles, reducing the surface area of lithium hydroxide that reacts with hydrogen sulfide. Therefore, the reaction space may be heated to a temperature of 160° C. or more to evaporate the water, so that high-purity lithium sulfide can be obtained.

Meanwhile, the higher the temperature of the reaction space, the more accelerated the reaction between lithium hydroxide and hydrogen sulfide. However, since the melting point of lithium hydroxide is 445° C., the temperature of the reaction space should preferably not exceed 445° C.

In addition, as the temperature of the reaction space increases, there is a greater risk of corrosion of an inner surface of the reaction chamber 100 by hydrogen sulfide. Therefore, the reaction chamber 100 may be made of a material with high heat resistance and corrosion resistance. For example, the reaction chamber 100 may be made of Hastelloy X or stainless steel 310 (SUS 310). In addition, the heating portion 310 may heat the reaction space to a temperature less than 300° C. Accordingly, frequent repair or replacement of equipment such as piping of the reaction chamber 100 can be prevented, and the reaction between hydrogen sulfide and the lithium raw material can be sufficiently promoted to obtain high-purity lithium sulfide.

The lithium raw material supply portion 200 may be provided to continuously supply a lithium raw material to the reaction chamber 100. Specifically, the lithium raw material supply portion 200 may be connected to a first reaction chamber 110, which is located most upstream in one direction. The type of lithium raw material supply portion 200 is not particularly limited. For example, the lithium raw material supply portion 200 may be a hopper.

Therefore, the lithium raw material is sequentially supplied to the plurality of reaction chambers 100 along one direction. In other words, the lithium raw material remaining after being supplied to the first reaction chamber 110 and being allowed to react may be transferred to the second reaction chamber 120, and similarly, the lithium raw material remaining after being supplied to the second reaction chamber 120 and being allowed to react may be transferred to the third reaction chamber 130.

The lithium raw material supply portion 200 may supply lithium hydroxide (LiOH) or lithium carbonate (Li₂CO₃), specifically lithium hydroxide, to the reaction chamber 100. Lithium hydroxide supplied to the reaction chamber 100 may react with hydrogen sulfide to produce lithium sulfide as shown in the following reaction scheme. In other words, it can be seen that when lithium hydroxide and hydrogen sulfide react, water is generated as a byproduct.

LiOH+H₂S→Li₂S+2H₂O

In addition, the supplied lithium raw material may have a particle size of 1 mm or less. Therefore, the reaction area with hydrogen sulfide may be increased, so that high-purity lithium sulfide is produced.

The hydrogen sulfide supply portion 300 may be provided to supply hydrogen sulfide to the reaction chamber 100. Specifically, the hydrogen sulfide supply portion 300 may sequentially supply hydrogen sulfide to the plurality of reaction chambers 100 along a direction opposite to the one direction from any one of the plurality of reaction chambers 100 other than the reaction chamber 100 into which the lithium raw material is supplied. For example, the hydrogen sulfide supply portion 300 may be connected to the third reaction chamber 130. In addition, the hydrogen sulfide remaining after being supplied to the third reaction chamber 130 and being allowed to react may be transferred to the second reaction chamber 120, and the hydrogen sulfide remaining after being supplied to the second reaction chamber 120 and being allowed to react may be transferred to the first reaction chamber 110.

To this end, the apparatus for manufacturing lithium sulfide according to the present invention may include a transfer line 400 provided between a reaction chamber located upstream in one direction and a reaction chamber located downstream in one direction among a pair of adjacent reaction chambers. For example, a transfer line 400 may be provided between the first reaction chamber 110 and the second reaction chamber 120 and between the second reaction chamber 120 and the third reaction chamber 130. The transfer line 400 may provide a passage for gas to flow between the two reaction chambers 100. In addition, a pump (not shown) for sucking gas within the reaction chamber 100 may be provided in the transfer line 400.

In addition, the moisture removal portion 450 may be provided in the transfer line 400. The moisture removal portion 450 is provided to recover gas discharged from the reaction chamber 100, remove water vapor from the gas, and then supply the gas from which water vapor has been removed to another reaction chamber 100. As described above, unreacted hydrogen sulfide that has not reacted with lithium hydroxide among the supplied hydrogen sulfide and water vapor generated by the reaction of hydrogen sulfide and lithium hydroxide may be present in the reaction chamber 100. This unreacted hydrogen sulfide is supplied again to the reaction chamber 100 located upstream in one direction, while the water vapor generated during the reaction needs to be removed. To this end, the moisture removal portion 450 may recover gas within the reaction chamber 100 through the transfer line 400, remove water vapor from the gas, and then supply the gas to the reaction chamber 100 located upstream in one direction.

The lithium sulfide recovery portion 500 is provided to recover lithium sulfide generated by the reaction between hydrogen sulfide and the lithium raw material within the reaction chamber 100. The lithium sulfide recovery portion 500 may be provided in the reaction chamber 100 located most downstream in one direction. For example, the lithium sulfide recovery portion 500 may be connected to the third reaction chamber 130. The structure of the lithium sulfide recovery portion 500 is not particularly limited. For example, it may be a chamber for capturing lithium sulfide.

The inert gas supply portion 600 may be installed in the reaction chamber located most downstream along one direction to supply an inert gas into the reaction chamber 100. Alternatively, the inert gas supply portion 600 may be installed in the lithium sulfide recovery portion 500. The inert gas supplied through the inert gas supply portion 600 may prevent the gas within the reaction chamber 100 from flowing backwards toward the downstream side in one direction.

When the inert gas supply portion 600 is installed in the lithium sulfide recovery portion 500, a transfer line 400 and a moisture removal portion 450 may also be installed between the third reaction chamber 130 and the lithium sulfide recovery portion 500. Therefore, when there is hydrogen sulfide that flows backwards from the third reaction chamber to the lithium sulfide recovery portion 500, the hydrogen sulfide may be supplied back to the third reaction chamber 130 through the transfer line 400.

In addition, when the inert gas supply portion 600 is directly connected to the third reaction chamber 130, the inert gas supply portion 600 may also serve to agitate the lithium raw material to promote its reaction with hydrogen sulfide. The type of inert gas supplied is not particularly limited. For example, helium, neon, argon, nitrogen, or the like may be used.

The inert gas discharge portion 800 may be provided to discharge an inert gas from the reaction chamber 100. Specifically, the inert gas discharge portion 800 may be provided in the first reaction chamber 110 located most upstream in one direction. Accordingly, the inert gas supplied from the downstream side in one direction may pass through the third reaction chamber 130, the second reaction chamber 120, and the first reaction chamber 110, and may prevent hydrogen sulfide from flowing backwards in one direction, and then be discharged to the outside through the inert gas discharge portion 800.

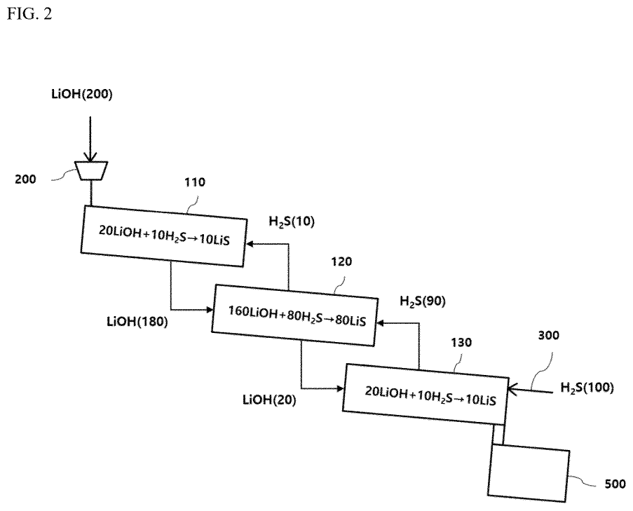

FIG. 2 is an exemplary diagram for describing a lithium sulfide manufacturing process according to one embodiment of the present invention. Hereinafter, the process of producing lithium sulfide by the apparatus for manufacturing lithium sulfide of the present invention will be described with reference to FIG. 2.

As described above, the lithium raw material is sequentially supplied to a plurality of reaction chambers 100 along one direction, and hydrogen sulfide is sequentially supplied to the plurality of reaction chambers 100 along the opposite direction. Therefore, differences may occur in the relative ratios of the lithium raw material and hydrogen sulfide reacting within each reaction chamber 100.

In other words, a relatively large amount of the lithium raw material may be present in the reaction chamber into which the lithium raw material is initially supplied compared to the amount of lithium sulfide produced, and a relatively large amount of the hydrogen sulfide may be present in the reaction chamber into which the hydrogen sulfide is initially supplied compared to the amount of lithium sulfide produced. Accordingly, the hydrogen sulfide in the reaction chambers 100 may have a reaction rate that increases toward the upstream side in one direction. Accordingly, the hydrogen sulfide reaction rate throughout the entire lithium sulfide production process can be improved, while simultaneously allowing the hydrogen sulfide to be completely consumed.

For convenience of explanation, it is assumed that 200 units of the lithium raw material are continuously supplied to the first reaction chamber 110, and 100 units of the hydrogen sulfide are continuously supplied to the third reaction chamber 130. Here, the numbers, 200, 100, and the like, are exemplary values indicating the ratio between components and represent relative amounts, not absolute amounts.

First, the reaction in the third reaction chamber 130 is described. While 100 units of the hydrogen sulfide are supplied to the third reaction chamber 130, the lithium raw material first reacts in the first reaction chamber 110 and the second reaction chamber 120 before being supplied to the third reaction chamber 130. Therefore, 20 units of the lithium raw material may be supplied to the third reaction chamber 130. In other words, a relatively large amount of the hydrogen sulfide is present in the third reaction chamber 130 compared to the amount of the lithium raw material, and also, since high-purity hydrogen sulfide is supplied to the third reaction chamber 130, high-quality lithium sulfide can be produced with high purity and high yield.

Lithium sulfide generated in the third reaction chamber 130 is transferred to and recovered in the lithium sulfide recovery portion 500, and unreacted hydrogen sulfide may be transferred to the second reaction chamber 120 via the transfer line 400. Since 20 units of the lithium raw material and 10 units of the hydrogen sulfide have previously reacted to produce 10 units of lithium sulfide, 90 units of the hydrogen sulfide are transferred to the second reaction chamber 120.

Next, the reaction in the second reaction chamber 120 is described. As previously discussed, 90 units of the hydrogen sulfide are supplied to the second reaction chamber 120, while 180 units of the lithium raw material remaining after reacting in the first reaction chamber 110 may be supplied. In other words, since relatively similar amounts of the lithium raw material and the hydrogen sulfide are present in the second reaction chamber 120, the hydrogen sulfide may not be completely consumed. For example, after 160 units of the lithium raw material and 80 units of the hydrogen sulfide react to produce 80 units of lithium sulfide, the remaining 20 units of the lithium raw material may be transferred to the third reaction chamber 130, and the remaining 10 units of the hydrogen sulfide may be transferred to the first reaction chamber 110.

Finally, the reaction in the first reaction chamber 110 is described. As described above, 10 units of the hydrogen sulfide are supplied to the first reaction chamber 110, while 200 units of the lithium raw material are supplied. In other words, there may be a sufficient amount of the lithium raw material in the first reaction chamber 110 to completely consume the supplied hydrogen sulfide. Therefore, when a cycle in which 100 units of hydrogen sulfide are supplied is considered one lithium sulfide production cycle, it means that the hydrogen sulfide supplied for one production cycle may be completely consumed. In other words, the reaction rate of hydrogen sulfide, which refers to the amount of hydrogen sulfide reacted relative to the amount of hydrogen sulfide supplied, can be improved, and by differently adjusting the ratio of the lithium raw material and the hydrogen sulfide in each reaction chamber 100, lithium sulfide can be produced with high purity and high yield. Meanwhile, the process is not limited to the above-described example and may be controlled to achieve a desired reaction rate of the hydrogen sulfide and complete consumption of the hydrogen sulfide by adjusting the amounts of the lithium raw material and the hydrogen sulfide supplied or by adjusting their residence time in each reaction chamber.

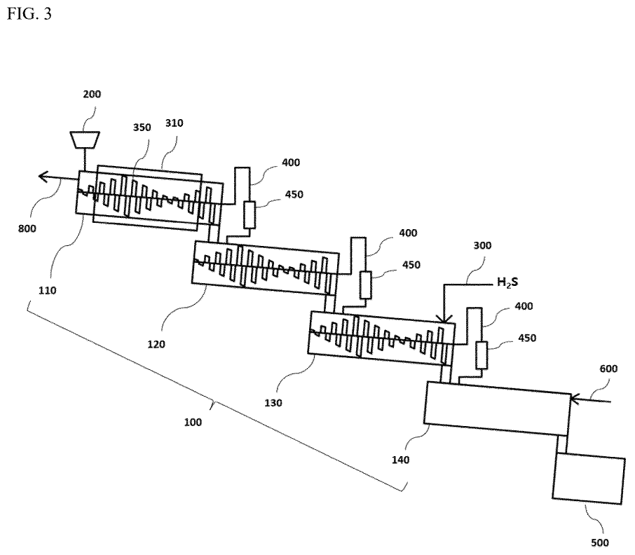

FIG. 3 is a schematic diagram illustrating an apparatus for manufacturing lithium sulfide according to another embodiment of the present invention. The apparatus for manufacturing lithium sulfide according to another embodiment of the present invention may further include an auxiliary chamber 140. For components identical or corresponding to those of the apparatus for manufacturing lithium sulfide according to the above-described embodiment, identical or corresponding reference numerals are assigned, and a detailed description thereof is omitted.

The auxiliary chamber 140 may be connected in series with a plurality of reaction chambers 100 and may be located downstream in one direction relative to the chamber into which hydrogen sulfide is supplied. Specifically, the auxiliary chamber 140 may be connected in series downstream of the third reaction chamber 130. Therefore, the produced lithium sulfide may be supplied to the auxiliary chamber 140. In addition, a lithium sulfide recovery portion 500 may be connected to the auxiliary chamber 140, so that the produced lithium sulfide may be recovered to the lithium sulfide recovery portion 500 through the auxiliary chamber 140.

In addition, a transfer line 400 and a moisture removal portion 450 may be provided between the third reaction chamber 130 and the auxiliary chamber 140. Therefore, when unreacted lithium raw material is present or hydrogen sulfide flows back to the auxiliary chamber 140 in one direction, a reaction may occur within the auxiliary chamber 140 to produce lithium sulfide. In addition, when unreacted hydrogen sulfide remains, it may be re-supplied to the third reaction chamber 130 through the transfer line 400. In other words, the auxiliary chamber 140 may serve as an auxiliary chamber when the reaction does not occur smoothly in the plurality of reaction chambers 100.

Meanwhile, the inert gas supply portion 600 may be connected to the auxiliary chamber 140 to more effectively prevent hydrogen sulfide from flowing backward in one direction. In addition, when necessary, a stirring member and a heating portion may be provided in the auxiliary chamber 140.

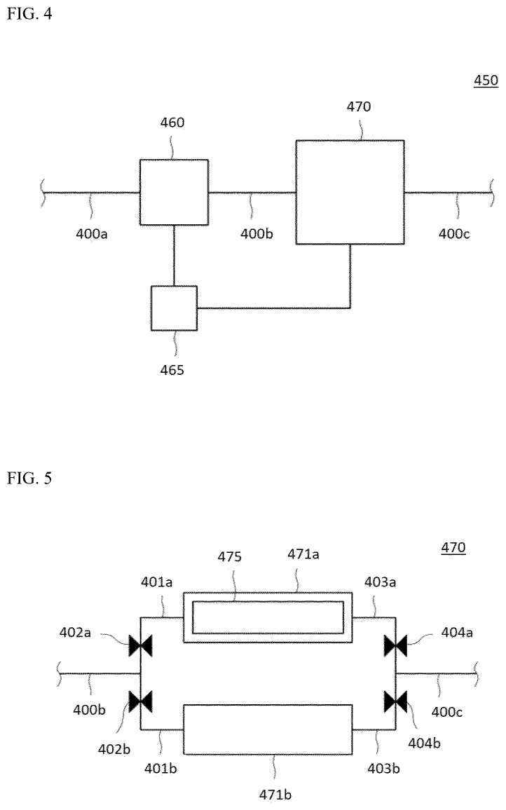

FIG. 4 is a moisture removal portion 450 according to another embodiment of the present invention. Specifically, the moisture removal portion is provided to recover gas discharged from the reaction chamber 100, remove water vapor from the gas, and supply the gas from which the water vapor has been removed to an upstream reaction chamber 100. As described above, unreacted hydrogen sulfide that has not reacted with lithium hydroxide among the supplied hydrogen sulfide and water vapor generated by the reaction of hydrogen sulfide and lithium hydroxide may be present in the reaction chamber 100. Such unreacted hydrogen sulfide is supplied to the upstream reaction chamber 100, whereas the water vapor generated during the reaction needs to be removed. To this end, the moisture removal portion 450 may recover gas from the reaction chamber 100 upstream of the reaction chamber 100 through the transfer line 400, remove water vapor, and supply the recovered gas to the downstream side of the upstream reaction chamber 100. Meanwhile, a supply means such as a circulation pump (not shown) may be used to supply the hydrogen sulfide gas from which the water vapor has been removed into the reaction chamber.

Referring to FIG. 4, the moisture removal portion 450 may include a liquefaction cooling portion 460 and a sublimation cooling portion 470. The liquefaction cooling portion 460 may perform primary cooling of the gas recovered from the reaction chamber 100 to selectively remove only moisture from the recovered gas. For example, the liquefaction cooling portion 460 may cool the gas recovered through a transfer line 400a to approximately 40° C. to liquefy water vapor, and the liquefied water may be removed through a discharge portion 465. The cooling structure of the liquefaction cooling portion 460 is not particularly limited, and may be, for example, a chamber provided with a cooling means (not shown).

Meanwhile, the sublimation cooling portion 470 may be provided to perform secondary cooling of the gas recovered from the reaction chamber 100 to remove moisture. For example, water vapor may be sublimated and removed by cooling it to approximately −30° C. The sublimation cooling portion 470 may additionally remove water vapor that is not removed by the liquefaction cooling portion 460 by recovering the gas that passes through the liquefaction cooling portion 460 through a transfer line 400b. Meanwhile, the terms “primary” and “secondary” used throughout the present specification and claims should be understood as arbitrarily assigning a sequence for the purpose of distinction.

Meanwhile, the terms “primary cooling” and “secondary cooling” do not mean a specific cooling sequence, and the moisture removal portion 450 may include either the liquefaction cooling portion 460 or the sublimation cooling portion 470 or may include both the liquefaction cooling portion 460 and the sublimation cooling portion 470.

FIG. 5 is a perspective view illustrating a sublimation cooling portion according to one embodiment of the present invention. The sublimation cooling portion 470 may include a cooling chamber 471, a cooling means 475 provided in the cooling chamber 471, and a control portion (not shown) for controlling the sublimation cooling portion 470. The control portion may be a control portion for controlling the apparatus for manufacturing lithium sulfide.

Water vapor supplied to the cooling chamber 471 is sublimated by the cooling means 475 and freezes on an inner surface of the cooling chamber 471. Since hydrogen sulfide has a boiling point of −59.6° C., it may pass through the cooling chamber 471 as is. Therefore, the cooling chamber 471 may remove only water vapor from the recovered gas and re-supply hydrogen sulfide to the reaction chamber 100.

However, since the sublimation cooling portion 470 causes a phase change by sublimating water vapor into an ice state and freezing it on an inner surface of the cooling chamber, in order to remove the frozen moisture on the inner surface of the cooling chamber 471, it is necessary to heat the cooling chamber 471 again to liquefy the ice. In other words, when only one cooling chamber 471 is provided, the operation of the apparatus for manufacturing lithium sulfide must be stopped in order to heat the cooling chamber 471, which makes it difficult to continuously carry out the process.

Therefore, the sublimation cooling portion 470 according to one embodiment of the present invention may be provided with a plurality of cooling chambers 471a and 471b, a plurality of branch lines 401 for transferring the recovered gas to each of the plurality of cooling chambers 471a and 471b, and a plurality of second branch lines 403 for supplying the gas in the plurality of cooling chambers 471 to a re-supply line 400c. The re-supply line 400c refers to a transfer line that supplies the recovered gas to another reaction chamber 100. In addition, the control portion may control cooling to be performed in the cooling chamber to which the recovered gas is transferred when the recovered gas is transferred to a preset cooling chamber among the plurality of cooling chambers 471.

The branch lines 401a and 401b and the second branch lines 403a and 403b may be respectively provided with first to fourth branch valves 402a, 402b, 404a, and 404b. The control portion may be provided to determine the cooling chambers 471a and 471b to which the recovered gas is transferred by controlling the branch valves 402a, 402b, 404a, and 404b provided in the branch lines 401a and 401b and the second branch lines 403a and 403b. For example, in order to transfer the recovered gas to the cooling chamber 471a located on the upper side of FIG. 5, the first branch valve 402a and the third branch valve 404a may be opened, and the second branch valve 402b and the fourth branch valve 404b may be closed.

After the upper cooling chamber 471a, to which the recovered gas is transferred, has been cooled for a predetermined period of time, it is necessary to heat and remove the ice that has been sublimated and frozen on an inner wall of the cooling chamber 471a. In this case, the control portion may control the recovered gas to be transferred to the lower cooling chamber 471b by operating the cooling means (not shown) provided in the lower cooling chamber 471b so that the lower cooling chamber 471b performs cooling. In other words, the first branch valve 402a and the third branch valve 404a may be closed, and the second branch valve 402b and the fourth branch valve 404b may be opened, thereby controlling the recovered gas to be transferred to the lower cooling chamber 471b. Accordingly, not only can lithium sulfide be continuously produced without stopping the apparatus for manufacturing lithium sulfide, but lithium sulfide production efficiency can also be improved by additionally removing moisture from the recovered gas, and high-purity lithium sulfide can be obtained.

Meanwhile, the control portion switches the upper cooling chamber 471a, which has been in cooling operation for a predetermined time, to heating, thereby liquefying and removing ice sublimated by cooling. A separate heating means may be provided in the cooling chamber 471, or moisture may be removed simply by stopping the operation of the cooling means 475 and maintaining the cooling chamber 471 at room temperature. The removed moisture may be transferred to the discharge portion 465 and removed.

In addition, instead of respectively providing the branch valves 402a, 402b, 404a, and 404b in the branch lines 401a, 401b, 403a, and 403b, three-way valves (not shown) may be provided at the branch point of the transfer line 400b and the branch line 401 and at the branch point of the branch line 403 and the re-supply line 400c. The control portion may control the three-way valves to determine the chamber to which the recovered gas is transferred.

In addition, the number of cooling chambers 471 is not particularly limited. When three or more cooling chambers 471 are provided, cooling may be performed simultaneously in multiple cooling chambers 471. The number of cooling chambers 471 may be appropriately provided depending on the amount of water vapor generated, such as the size of the reaction chamber 100, the temperature to which the heating portion 310 heats the reaction space, and the like.

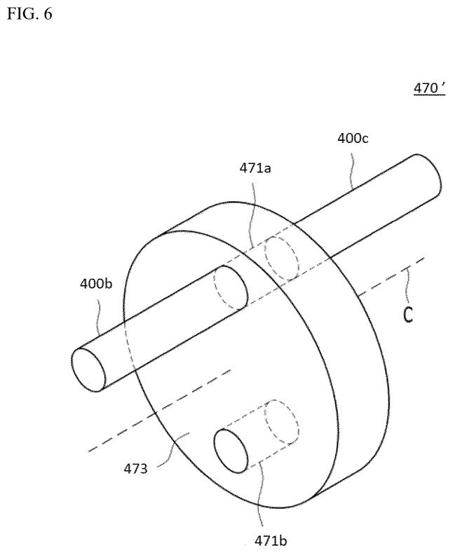

FIG. 6 is a perspective view illustrating a sublimation cooling portion according to another embodiment of the present invention. The sublimation cooling portion 470′ according to another embodiment of the present invention differs from the sublimation cooling portion 470 according to the above-described embodiment in that it has a main body 473 that is rotatable around an axis C parallel to the direction in which the recovered gas is transferred. In addition, a plurality of cooling chambers 471 may be formed to pass through the main body 473 along the axis C parallel to the direction in which the recovered gas is transferred. In addition, the sublimation cooling portion 470′ according to the present embodiment does not have a branch line 401, but instead, at least one of the plurality of cooling chambers 471 may be provided to communicate with the transfer line 400b and the re-supply line 400c.

In other words, the control portion controls some of the plurality of cooling chambers 471 to perform cooling, and by rotating the main body 473 around the axis C, the cooling chambers 471 performing cooling may be controlled to communicate with the transfer line 400b and the re-supply line 400c.

More specifically, when the cooling chamber 471a located on the upper side of FIG. 6 is cooled by a cooling means (not shown) while being connected to the transfer line 400b and the re-supply line 400c, as the recovered gas passes through the upper cooling chamber 471a, water vapor may be sublimated and frozen inside the cooling chamber, thereby being removed from the recovered gas. However, when the space inside the cooling chamber becomes small after the upper cooling chamber 471a through which the recovered gas is transferred has been cooled for a predetermined time, and the frozen ice needs to be removed, the control portion controls the lower cooling chamber 471b to perform cooling and then rotates the main body 473 around the axis C to change the cooling chamber 471 to which the recovered gas is transferred to the lower cooling chamber 471b. In addition, by switching the cooling chamber 471a in which cooling has been performed for a predetermined time to heating, the ice sublimated by the cooling may be liquefied and removed.

Also in the sublimation cooling portion 470′ according to the present embodiment, the cooling chamber 471 to which the recovered gas is transferred may be changed simply by rotating the main body 473 around the axis C, so that lithium sulfide can be produced continuously without stopping the apparatus for manufacturing lithium sulfide, which is efficient, and moisture can be removed more thoroughly to obtain high-purity lithium sulfide.

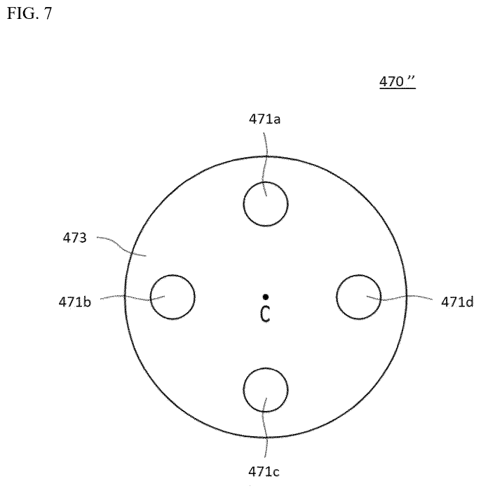

FIG. 7 is a front view illustrating a sublimation cooling portion according to another embodiment of the present invention. The sublimation cooling portion 470″ according to this embodiment differs from the previously described sublimation cooling portion 470′ in that it includes three or more cooling chambers 471. The number of cooling chambers 471 is not particularly limited.

For example, as shown in FIG. 7, when four cooling chambers 471a, 471b, 471c, and 471d are formed to pass through the main body 473, at least one cooling chamber may be provided to communicate with the transfer line 400b and the re-supply line 400c. In addition, the control portion may control sequential cooling operation of the plurality of cooling chambers 471a, 471b, 471c, and 471d and control transfer of the recovered gas to a cooling chamber where cooling is in progress, by rotating the main body 473 around the axis C. Likewise, for a cooling chamber that has been operated for a predetermined time, heating may be performed so that ice sublimated by cooling may be liquefied and removed.

Alternatively, the sublimation cooling portion 470″ according to the present embodiment may be controlled to perform cooling in a plurality of cooling chambers 471a and 471b, and in this case, a plurality of lines branching from the transfer line 400b may be provided to communicate with each of the plurality of cooling chambers 471a and 471b that perform cooling. The number of cooling chambers 471 may be appropriately provided based on the size of the reaction chamber 100, the temperature to which the heating portion 310 heats the reaction space, the amount of water vapor generated, and the like.

The gas recovered from the reaction chamber 100 and from which moisture has been removed may be re-supplied to an upstream reaction chamber 100 via the re-supply line 400c (see FIG. 1). The re-supply line 400c may be connected to a downstream end of the reaction chamber 100. Since the lithium raw material supplied into the reaction chamber 100 will fall to a lower part of the reaction chamber 100 by gravity and then move, the hydrogen sulfide supplied through the re-supply line 400c may secure a sufficient reaction time with the lithium raw material.

The above description is merely an illustrative description of the technical idea of the present invention, and those skilled in the art will understand that various modifications and changes can be made without departing from the essential features of the present invention. Therefore, the embodiments disclosed in the present invention are intended to illustrate, rather than limit, the technical idea of the present invention, and the scope of the technical idea of the present invention is not limited by these embodiments. The scope of protection of the present invention should be interpreted by the following claims, and all technical ideas within a scope equivalent thereto should be interpreted as being included in the scope of the rights of the present invention.

### REFERENCE NUMERALS

100: Reaction chamber
110: First reaction chamber
120: Second reaction chamber
130: Third reaction chamber
140: Auxiliary chamber
200: Lithium raw material supply portion
300: Hydrogen sulfide supply portion
310: Heating portion
350: Stirring member
400, 400a, 400b, 400c: Transfer line
401: Branch line
403: Second branch line
402a: First branch valve
402b: Second branch valve
404a: Third branch valve
404b: Fourth branch valve
450: Moisture removal portion
460: Liquefaction cooling portion
465: Discharge portion
470: Sublimation cooling portion
471: Cooling chamber
475: Cooling means
473: Main body
C: Axis
500: Lithium sulfide recovery portion
600: Inert gas supply portion
800: Inert gas discharge portion

What is claimed is:

1. An apparatus for manufacturing lithium sulfide, comprising:
a plurality of reaction chambers having a reaction space for producing lithium sulfide by a reaction between a lithium raw material and hydrogen sulfide and provided to move the supplied lithium raw material along one direction,
wherein the lithium raw material is sequentially supplied to the plurality of reaction chambers along the one direction, and
the hydrogen sulfide is sequentially supplied to the plurality of reaction chambers along a direction opposite to the one direction from any one of the plurality of reaction chambers other than the reaction chamber into which the lithium raw material is supplied.

2. The apparatus of claim 1, wherein in a reaction chamber into which the lithium raw material is initially supplied, a large amount of lithium raw material is present compared to the amount of lithium sulfide produced, and
in a reaction chamber into which the hydrogen sulfide is initially supplied, a large amount of hydrogen sulfide is present compared to the amount of lithium sulfide produced.

3. The apparatus of claim 1, wherein, in the plurality of reaction chambers, the hydrogen sulfide in the reaction chamber has a reaction rate that increases toward an upstream side of the one direction.

4. The apparatus of claim 1, wherein the plurality of reaction chambers include a first reaction chamber, a second reaction chamber, and a third reaction chamber connected in series,
the apparatus further comprising:
a lithium raw material supply portion provided to supply the lithium raw material to the first reaction chamber; and
a hydrogen sulfide supply portion provided to supply the hydrogen sulfide to the third reaction chamber.

5. The apparatus of claim 1, further comprising:
a lithium raw material supply portion provided to supply the lithium raw material to the reaction chamber;
a hydrogen sulfide supply portion provided to supply the hydrogen sulfide to the reaction chamber;
a plurality of heating portions respectively provided in the plurality of reaction chambers to heat the reaction space; and
a lithium sulfide recovery portion provided to recover lithium sulfide produced in the reaction chamber.

6. The apparatus of claim 1, further comprising:
an inert gas supply portion provided in the reaction chamber located most downstream along the one direction among the plurality of reaction chambers to supply an inert gas into the reaction chamber; and
an inert gas discharge portion provided in the reaction chamber located most upstream along the one direction among the plurality of reaction chambers to discharge the inert gas in the reaction chamber.

7. The apparatus of claim 1, wherein the plurality of chambers include an auxiliary chamber located downstream in the one direction relative to the chamber to which the hydrogen sulfide is supplied,
the apparatus further comprising an inert gas supply portion supplying an inert gas to the auxiliary chamber.

8. The apparatus of claim 1, further comprising:
a transfer line provided between one of the reaction chambers located upstream in one direction and the other of the reaction chambers located downstream in one direction among a pair of adjacent reaction chambers, the transfer line providing a passage through which gas in the other of the reaction chambers flows into the one of the reaction chambers; and
a moisture removal portion provided in the transfer line to remove water vapor in the gas flowing in the transfer line.

9. The apparatus of claim 1, wherein the reaction chamber is made of Hastelloy X or stainless steel 310 (SUS 310).

10. The apparatus of claim 1, further comprising a plurality of heating portions respectively provided in the plurality of reaction chambers to heat the reaction space, wherein the heating portion is mounted on an outer surface of the reaction chamber and heat the reaction space to a temperature to 160° C. or more and less than 300° C.

11. The apparatus of claim 1, further comprising a lithium raw material supply portion provided to supply the lithium raw material to the reaction chamber, wherein the lithium raw material supplied from the lithium raw material supply portion to the reaction chamber has a particle size of 1 mm or less.
